(19) United States
(12) Patent Application Publication
(10) Pub. No.: US 2018/0157505 A1
(43) Pub. Date: Jun. 7, 2018

(54) AUTOMATED IMAGE LAYER BLACKLISTING IN THE CLOUD

(71) Applicant: INTERNATIONAL BUSINESS MACHINES CORPORATION, Armonk, NY (US)

(72) Inventors: Sudheesh S. Kairali, Kerala (IN); Neeraj K. Kashyap, Bangalore (IN)

(21) Appl. No.: 15/366,322

(22) Filed: Dec. 1, 2016

(51) Int. Cl. G06F 9/455; G06F 11/36; H04L 12/24

(52) U.S. Cl. CPC G06F 9/45504; H04L 67/10; H04L 41/0803; G06F 11/3668

(57) ABSTRACT

A computer-implemented method is provided. The method includes identifying, by one or more processors, faulty layers from among a plurality of layers of a container image stored in a container-based cloud system. The method further includes storing, by the one or more processors, information regarding the container image and the faulty layers of the container image. The method also includes automatically blacklisting, by the one or more processors, the container image responsive to an identification of one or more of the faulty layers of the container image. The method additionally includes preventing, by the one or more processors, use of any of the faulty layers in a provisioning process in a container-based cloud system.

### BACKGROUND

### Technical Field

The present invention relates generally to cloud computing and, in particular, to automated container image layer blacklisting in the cloud.

### Description of the Related Art

Cloud provisioning has been performed using Docker® containers. Docker® containers are affordable and flexible, with a broad range of features that include on-demand, self-service, and so forth.

One of the merits of Docker® clouds is that Docker® images have a way of becoming building blocks of future Docker® images. Every Docker® image includes a set of layers which make up the final image. Once layers or intermediate images are built, they can be reused for new builds. Such reuse makes the builds significantly faster. Moreover, such reuse is helpful for continuous integration, where we want to build an image at the end of each successful build. Also, the images are smaller, since intermediate images are shared between images. Another important aspect is rollback, since every image includes all of its building steps, a user can easily go back to a previous step.

However, current techniques for cloud provisioning using Docker® containers can implicate certain problems. For example, consider when one of the layers/images (e.g., an intermediate layer/image) has problems such as post-provisioning (e.g., security related, performance related, etc.) problems or is unable to provision in the first place, and many other images are built on that layer/image. Currently, conventional techniques for cloud provisioning using Docker® containers cannot prevent usage of any faulty image or any image which used the faulty image as a layer. As such, there is a need for improved cloud provisioning using containers such as, but not limited to, Docker® containers.

### SUMMARY

According to an aspect of the present invention, a computer-implemented method is provided. The method includes identifying, by one or more processors, faulty layers from among a plurality of layers of a container image stored in a container-based cloud system. The method further includes storing, by the one or more processors, information regarding the container image and the faulty layers of the container image. The method also includes automatically blacklisting, by the one or more processors, the container image responsive to an identification of one or more of the faulty layers of the container image. The method additionally includes preventing, by the one or more processors, use of any of the faulty layers in a provisioning process in a container-based cloud system.

According to another aspect of the present invention, a computer program product is provided for image blacklisting in a container-based cloud system. The computer program product includes a non-transitory computer readable storage medium having program instructions embodied therewith. The program instructions are executable by a computer to cause the computer to perform a method. The method includes identifying, by one or more processors, faulty layers from among a plurality of layers of a container image stored in the container-based cloud system. The method further includes storing, by the one or more processors, information regarding the container image and the faulty layers of the container image. The method also includes automatically blacklisting, by the one or more processors, the container image responsive to an identification of one or more of the faulty layers of the container image. The method additionally includes preventing, by the one or more processors, use of any of the faulty layers in a provisioning process in a container-based cloud system.

According to yet another aspect of the present invention, a computer processing system is provided. The computer processing system includes one or more processors. The one or more processors are configured to identify faulty layers from among a plurality of layers of a container image stored in a container-based cloud system. The one or more processors are further configured to store information regarding the container image and the faulty layers of the container image. The one or more processors are also configured to automatically blacklist the container image responsive to an identification of one or more of the faulty layers of the container image. The one or more processors are additionally configured to prevent use of any of the faulty layers in a provisioning process in a container-based cloud system.

These and other features and advantages will become apparent from the following detailed description of illustrative embodiments thereof, which is to be read in connection with the accompanying drawings.

### BRIEF DESCRIPTION OF DRAWINGS

The following description will provide details of preferred embodiments with reference to the following figures wherein:

FIG. 1 shows an exemplary processing system to which the present invention may be applied, in accordance with an embodiment of the present invention;

FIG. 2 shows an exemplary environment to which the present invention can be applied, in accordance with an embodiment of the present invention;

FIG. 3 shows an exemplary method for automated image layer blacklisting in the cloud, in accordance with an embodiment of the present invention;

FIG. 4 shows an exemplary container image issues table, in accordance with an embodiment of the present invention;

FIG. 5 shows an exemplary blacklisted container image details table, in accordance with an embodiment of the present invention;

FIG. 6 shows an exemplary method for reporting issues to the container image issues table of FIG. 4, in accordance with an embodiment of the present invention;

FIG. 7 shows an exemplary method for blacklisting container images, in accordance with an embodiment of the present invention;

FIG. 8 shows an exemplary method for using blacklisting information in a container cloud management system, in accordance with an embodiment of the present invention;

FIG. 9 shows an exemplary cloud computing environment, in accordance with an embodiment of the present invention; and

FIG. 10 shows an exemplary set of functional abstraction layers provided by the cloud computing environment shown in FIG. 9, in accordance with an embodiment of the present invention.

### DETAILED DESCRIPTION

The present invention is directed to automated container image layer blacklisting in the cloud. The present invention can be used with respect to any container management system that represents an image by different layers. In general, a container includes an application and all of its dependencies, but can share the kernel with other containers, running as isolated processes in user space on the host operating system. In general, containers are not tied to any specific infrastructure and, as such, they can run on any computer, on any infrastructure, and in any cloud.

In an embodiment, containers can be created and managed in order to build a highly distributed system by allowing multiple applications, worker tasks and other processes to run autonomously on a single physical machine or across multiple (e.g., virtual) machines. This allows the deployment of nodes to be performed as the resources become available or when more nodes are needed, allowing a platform as a service (Paas) type of deployment, and so forth.

In an embodiment, the present invention automatically identifies faulty images by analyzing each layer of a container image with respect to a set of issues. In an embodiment, the present invention provides a mechanism by which a faulty image is blacklisted and, thus, will not be used for future operations (e.g., for building other images, and so forth).

In an embodiment, the present invention uses Docker® containers. Docker® containers wrap up a piece of software in a complete filesystem that includes everything it needs to run such as, for example: code; runtime; system tools; system libraries; and so forth. In this way, the software will always run the same, regardless of the environment in which the software is running.

It is to be appreciated that while one or more embodiments are described herein with respect to Docker® containers, the present invention can be applied to any container management system as readily appreciated by one of ordinary skill in the art given the teachings of the present invention provided herein, while maintaining the spirit of the present invention.

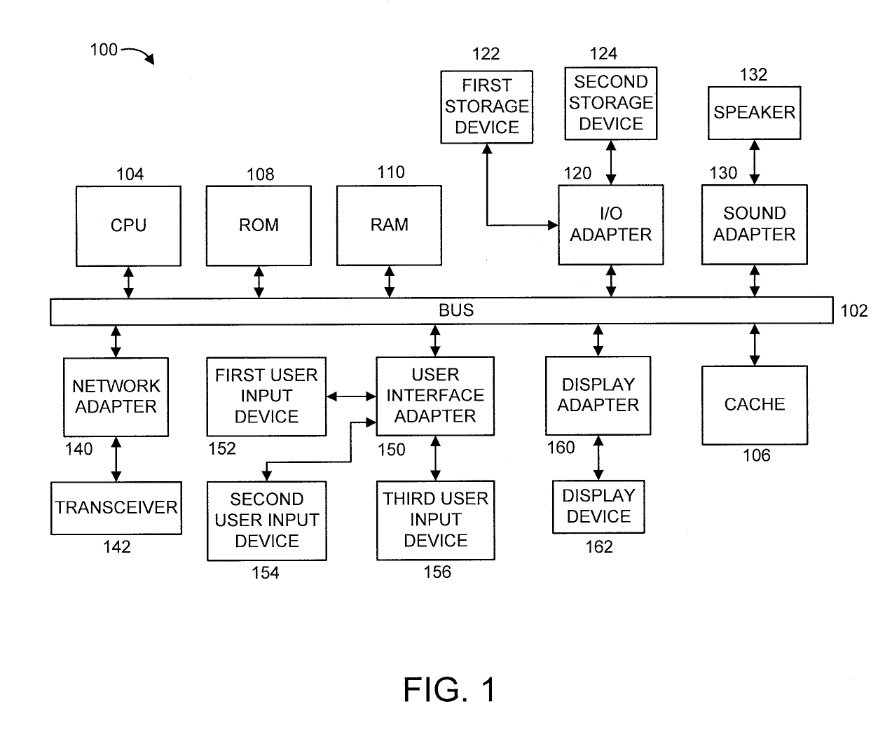

FIG. 1 shows an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

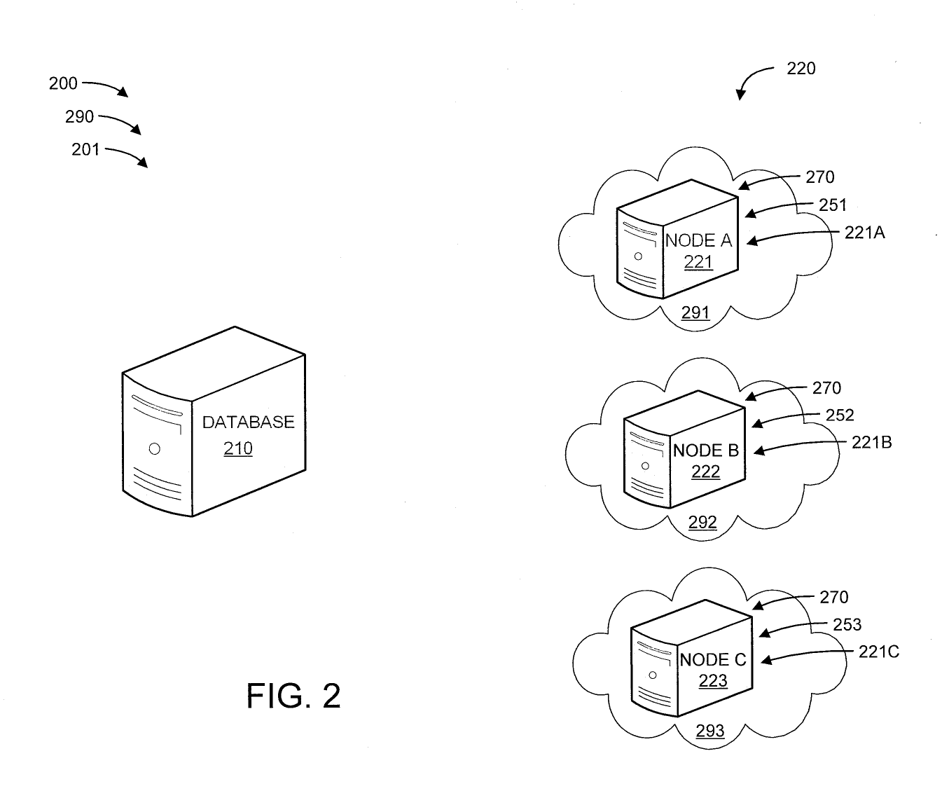

Moreover, it is to be appreciated that environment 200 described below with respect to FIG. 2 is an environment for implementing respective embodiments of the present invention. Part or all of processing system 100 may be implemented in one or more of the elements of environment 200.

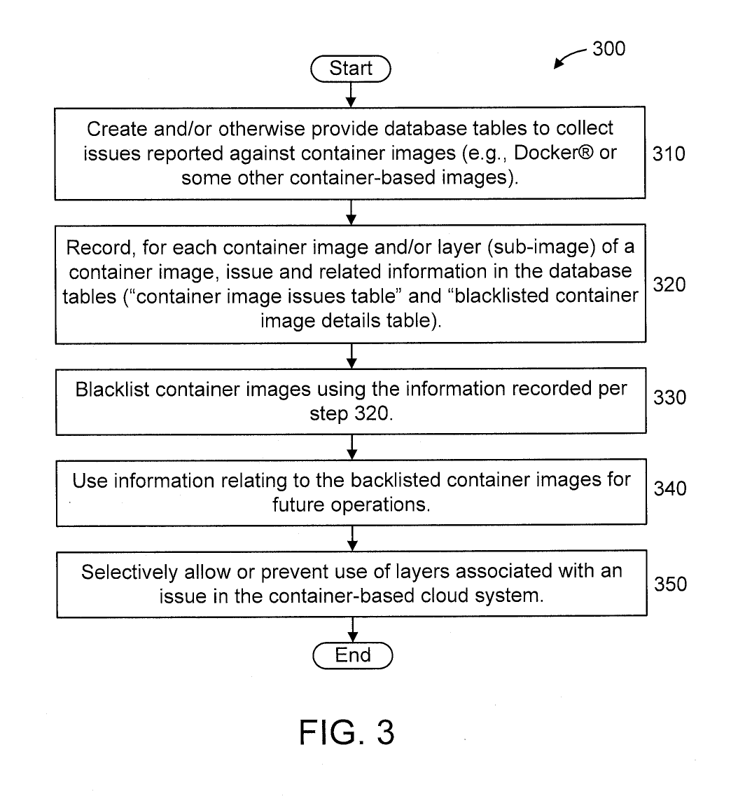

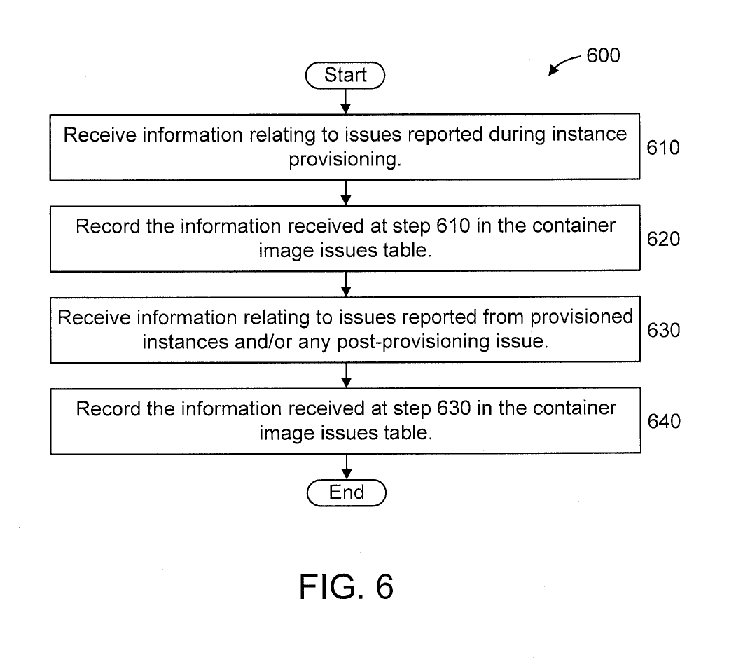

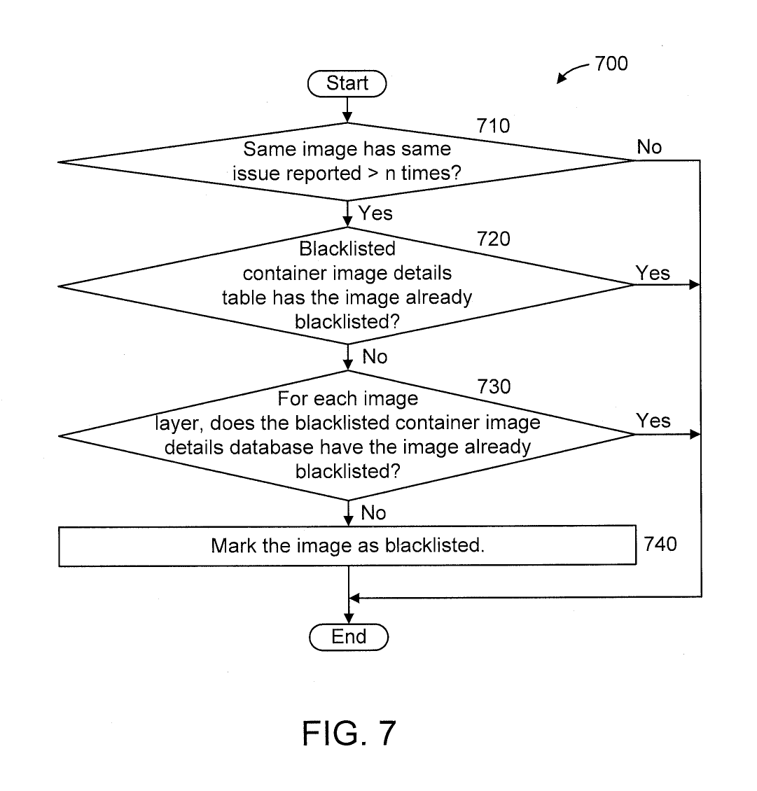

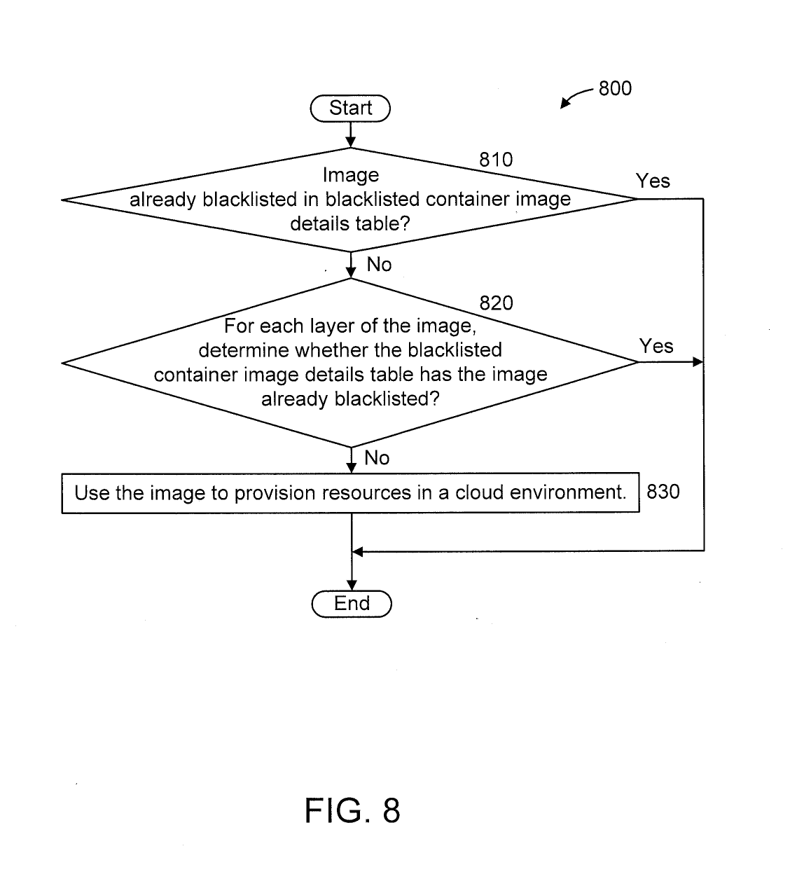

Further, it is to be appreciated that processing system 100 may perform at least part of the methods described herein including, for example, at least part of method 300 of FIG. 3 and/or at least part of method 600 of FIG. 6 and/or at least part of method 700 of FIG. 7 and/or at least of method 800 of FIG. 8. Similarly, part or all of system 200 may be used to perform at least part of method 300 of FIG. 3 and/or at least part of method 600 of FIG. 6 and/or at least part of method 700 of FIG. 7 and/or at least of method 800 of FIG. 8.

FIG. 2 shows an exemplary environment 200 to which the present invention can be applied, in accordance with an embodiment of the present invention.

The environment 200 at least includes a computer processing system 210 and a set of nodes 220. The database 210 and the set of nodes 220 are part of one or more cloud cluster systems (hereinafter “cloud cluster system”) 290.

The computer processing system 210 can be, for example, a server.

In the example of FIG. 2, the set of nodes includes node A 221, node B 222, and node C 223. Each of nodes corresponds to a respective cluster of the cloud cluster system 290. In particular, node A 221 corresponds to cluster 291 of cloud cluster system 290, node B 222 corresponds to cluster 292 of cloud cluster system 290, and node C 223 corresponds to cluster 293 of cloud cluster system 290. However, it is to be appreciated that in other embodiments the multiple nodes can be in the same cluster. Moreover, it is to be appreciated that in other embodiments, the clusters can have different numbers of nodes therein.

Each of the nodes can be implemented by a respective server, where each of the servers includes a respective local memory. In particular, node A 221 includes local memory 251, node B 222 includes local memory 252, and node C includes local memory 253. The local memories 251, 252, and 253 can be implemented by caches or other types of memory (and are hereinafter interchangeably referred to as caches).

In environment 200, images are evaluated (for the purpose of blacklisting and related purposes) across the nodes 220 of the cloud cluster system 290. The evaluation can be performed by computer processing system 210 or any of the nodes in set 220. In another embodiment, computer processing system 210 is used to evaluate images in the nodes in set 220. These and other evaluation configurations are readily determined by one of ordinary skill in the art, while maintaining the spirit of the present invention. In an embodiment, image evaluation for the purpose of blacklisting and related purposes can be achieved across the multiple instances using, for example, REpresentational State Transfer (REST) calls. However, other types of calls that expose resources can also be used by the invention, while maintaining the spirit of the present invention.

In the embodiment of FIG. 2, node A 221 includes a respective instance 221A, node B 222 includes a respective instance 222A, and node C 223 includes a respective instance 223A.

While the example of FIG. 2 is essentially limited to a single instance on each of the nodes in cloud cluster system 290 for the sake of illustration and clarity, it is to be appreciated that there can be a multiple nodes/instances on multiple cluster systems, each having image data for images that can be evaluated for the purpose of blacklisting and related purposes.

In the embodiment shown in FIG. 2, the elements thereof are interconnected by a network(s) 201. However, in other embodiments, other types of connections can also be used. Moreover, in an embodiment, at least one of the elements of environment 200 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of system 200 are readily determined by one of ordinary skill in the art, given the teachings of the present invention provided herein, while maintaining the spirit of the present invention.

FIG. 3 shows an exemplary method 300 for automated image layer blacklisting in the cloud, in accordance with an embodiment of the present invention.

At step 310, create and/or otherwise provide database tables to collect issues reported against container images (e.g., Docker® or some other container-based images).

Regarding step 310, an embodiment thereof can involve the following:

(1) a first database table (also interchangeably referred to as a “container image issues table”) which includes details of all images for which at least one issue has been reported while provisioning instances or post provision issues reported from instances spawned out of these images; and
(2) a second database table (also interchangeably referred to as a “blacklisted container image details table”) which includes details of all images which are blacklisted.

At step 320, record, for each container image and/or layer (sub-image) of a container image, issue and related information in the database tables (“container image issues table” and “blacklisted container image details table). The issue and related information can pertain to one or more layers of a container image.

At step 330, blacklist container images using the information recorded per step 320.

At step 340, use information relating to the backlisted container images for future operations. In an embodiment, step 340 includes step 340A.

At step 340A, selectively allow or prevent use of layers associated with an issue in the container-based cloud system. For example, for images having no layers with issues, spawning of instances from the image and/or its layers is allowed, while for images having one or more layers with an issue, spawning of instances from the image and/or its layers is prevented. As a further example relating to images having no layers with issues, such images can be reused for instance spawning, uploaded to a repository (e.g., for future reuse, etc.), and so forth.

It is to be appreciated that step 320 and 330 are related in the fact that the act of recording information for an image as performed in step 320 can correct to the act of blacklisting the image as performed in step 320. In further detail, the recording of information in a data construct (e.g., a table such as table 400 and/or table 500) can serve the function of blacklisting an image and/or one or more layers of the image, as readily appreciated by one of ordinary skill in the art given the teachings of the present invention provided herein.

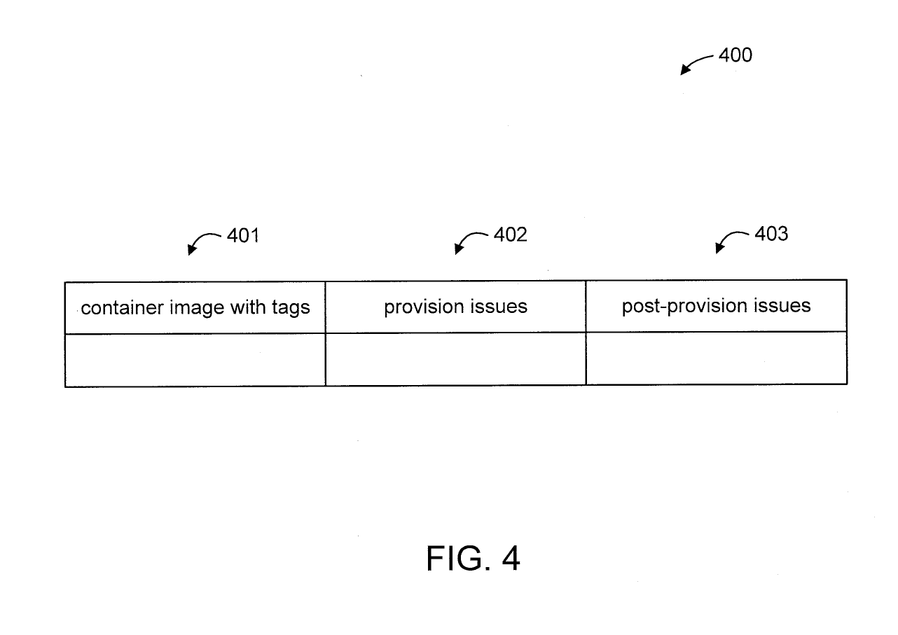

FIG. 4 shows an exemplary container image issues table 400, in accordance with an embodiment of the present invention.

The container image issues table 400 includes a first column 401, a second column 402, and a third column 403. The first column 401, having a heading entitled “container image with tags”, specifies images that have reported issues. The second column 402, having a heading entitled “provision issues”, specifies issues reported while provisioning cloud resources. The third column 403, having a heading entitled “post-provision issues”, specifies the issues reported for instances of an image listed/specified in the first column 401. The tags in column 401 are unique identifiers for the images.

Of course, the information specified in columns 401-403 in table 400 can vary depending upon the implementation. Thus, other information can also be included in addition to, or in place of, the information depicted in FIG. 4, while maintaining the spirit of the present invention.

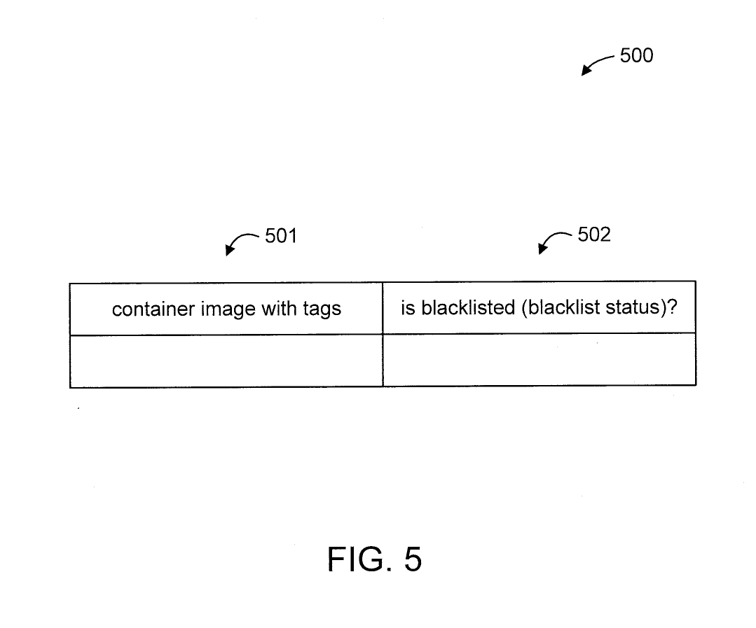

FIG. 5 shows an exemplary blacklisted container image details table 500, in accordance with an embodiment of the present invention.

The blacklisted container image details table 500 includes a first column 501 and a second column 502. The first column 501, having a heading entitled “container image with tags”, specifies the images which are blacklisted. The second column 502, having a heading entitled “is blacklisted (blacklist status)?”, specifies a value (e.g., a Boolean value) to indicate whether an image is blacklisted (that is, its' blacklist status). The tags in column 501 are unique identifiers for the images.

Of course, the information specified in columns 501-502 in table 500 can vary depending upon the implementation. Thus, other information can also be included in addition to, or in place of, the information depicted in FIG. 5, while maintaining the spirit of the present invention.

FIG. 6 shows an exemplary method 600 for reporting issues to the container image issues table 400 of FIG. 4, in accordance with an embodiment of the present invention. The reporting of issues can relate provisioning or post-provisioning of cloud resources.

At step 610, receive information relating to issues reported during instance provisioning. The information can include, for example, but is not limited to, issues reported while spawning new instances from any container image. Moreover, the information includes identifying information of the image from which a new instance is spawned.

At step 620, record the information received at step 610 in the container image issues table. In an embodiment, the identifying information of the image (that has an issue reported against it) is recorded in column 401 of table 400, and the provisioning issue is recorded in column 402 of table 400.

At step 630, receive information relating to issues reported from provisioned instances and/or any post-provisioning issue. The information can include, for example, but is not limited to, security and performance issues reported from any instances. Moreover, the information includes identifying information of the image from which a new instance is spawned.

At step 640, record the information received at step 630 in the container image issues table. In an embodiment, the identifying information of the image (that has an issue reported against it) is recorded in column 401 of table 400, and the post-provisioning issue is recorded in column 403 of table 400.

FIG. 7 shows an exemplary method 700 for blacklisting container images, in accordance with an embodiment of the present invention.

At step 710, determine whether or not the same container image has the same issue (provisioning or post provisioning) reported against it n times. In an embodiment, the value of n is user configurable. If so, then proceed to step 720. Otherwise, terminate the method.

At step 720, determine whether or not the blacklisted container image details table has the image already blacklisted. If so, then terminate the method. Otherwise, proceed to step 730.

At step 730, for each layer of the image, determine whether or not the blacklisted container image details database has the image already blacklisted. If so, then terminate the method. Otherwise, proceed to step 740.

At step 740, mark the image as blacklisted. For example, step 740 can involve specifying a value in column 502 of FIG. 5 to indicate that the image is blacklisted.

In an embodiment, method 700 is performed for each different image in the container image issues table. This can be implemented as a background job which will periodically scan the container image issues table.

FIG. 8 shows an exemplary method 800 for using blacklisting information in a container cloud management system, in accordance with an embodiment of the present invention.

At step 810, determine whether or not an image is already blacklisted in the blacklisted container image details table.

At step 820, for each layer of the image, determine whether or not the blacklisted container image details table has the image already blacklisted. If so, then terminate the method. Otherwise, proceed to step 830. It is to be appreciated that step 810 differs from step 820 in that each layer of an image is considered, noting that any of the columns in the blacklisted container image details table can include information at an image-layer level of granularity, depending upon the implementation.

At step 830, use the image to provision resources in a cloud environment. For example, step 830 can involve spawn instances for cloud provisioning in the cloud environment.

In an embodiment, method 800 is performed, for example, while spawning a new instance using an image or uploading a new image to a repository.

Thus, the present invention can blacklist container images efficiently and automatically while taking the layering concept into consideration.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

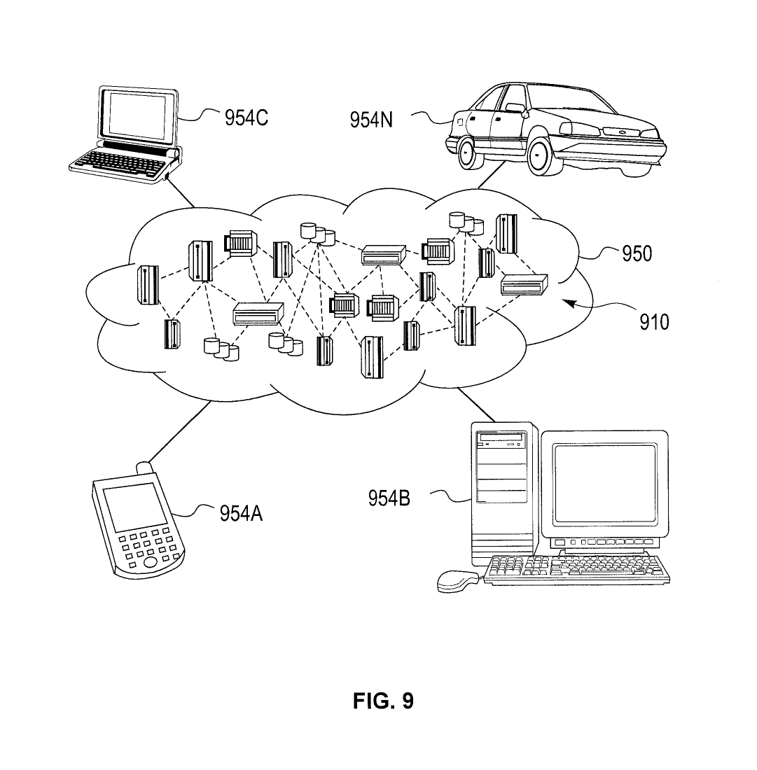

Referring now to FIG. 9, illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

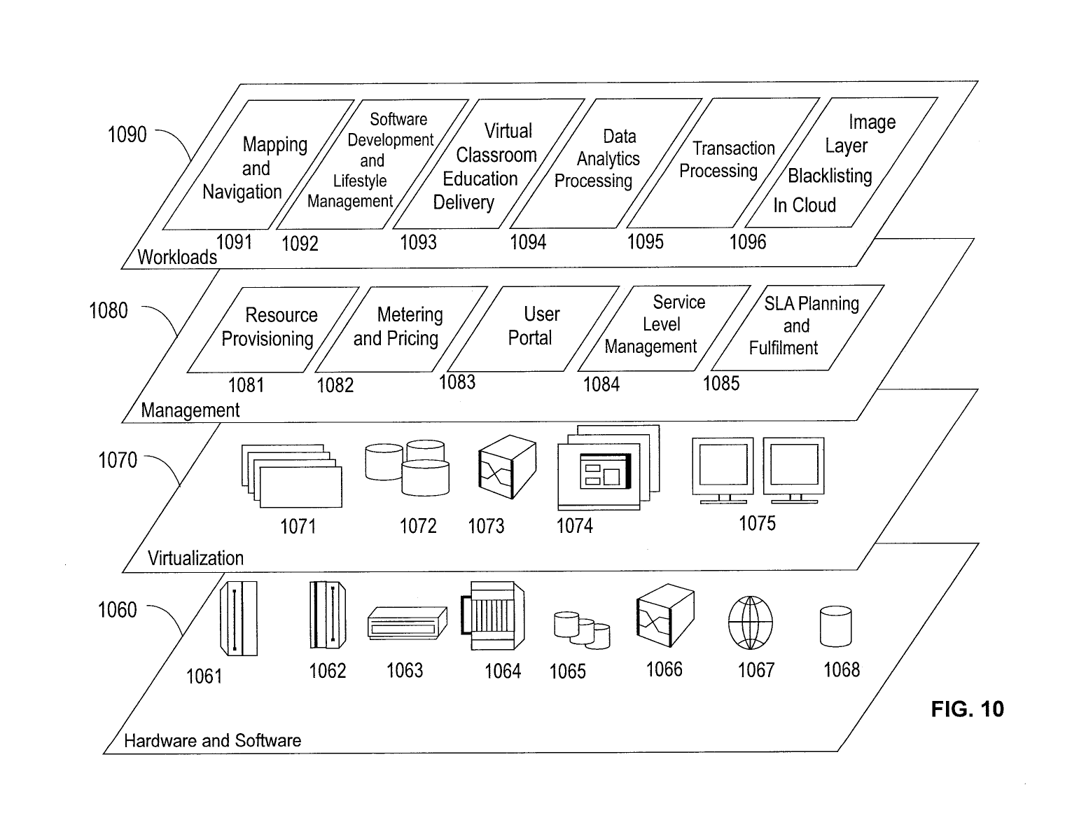

Referring now to FIG. 10, a set of functional abstraction layers provided by cloud computing environment 950 (FIG. 9) is shown. It should be understood in advance that the components, layers, and functions shown in FIG. 13 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; virtual classroom education delivery 1093; data analytics processing 1094; transaction processing 1095; and image layer blacklisting in cloud 1096.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
identifying, by one or more processors, faulty layers from among a plurality of layers of a container image stored in a container-based cloud system;
storing, by the one or more processors, information regarding the container image and the faulty layers of the container image;
automatically blacklisting, by the one or more processors, the container image responsive to an identification of one or more of the faulty layers of the container image; and
preventing, by the one or more processors, use of any of the faulty layers in a provisioning process in a container-based cloud system.

2. The computer-implemented method of claim 1, wherein said identifying step comprises identifying the faulty layers by analyzing each of the plurality of layers of the container image for any issues reported with respect to at least selected from the group consisting of provisioning or post provisioning processes.

3. The computer-implemented method of claim 2, wherein the issues reported with respect to the provisioning processes relate to provisioning issues occurring when provisioning instances of one or more of the faulty layers.

4. The computer-implemented method of claim 2, wherein the issues reported with respect to the post-provisioning processes relate to post-provisioning issues reported from instances spawned from one or more of the faulty layers.

5. The computer-implemented method of claim 1, wherein the method is performed with respect to a set of container images, and wherein the information comprises (i) a unique identifier for each of the container images in the set, (ii) issue data for any issues reported with respect to (a) the container images in the set and (b) images instantiated from the container images in the set, and (iii) a blacklisted status of each of the container images in the set.

6. The computer-implemented method of claim 1, wherein the method is performed with respect to a set of container images, and wherein the information comprises (i) a unique identifier for each of the container images in the set that have reported issues, (ii) the reported issues relating to provisioning cloud resources, and (iii) the reported issues relating to one or more instances spawned from any of the container images in the set.

7. The computer-implemented method of claim 1, wherein the method is performed with respect to a set of container images, and wherein the information comprises (i) a unique identifier for each of the container images in the set and (ii) a blacklisted status of each of the container images in the set.

8. The computer-implemented method of claim 1, further comprising provisioning resources in the container-based cloud system using the container image, when the container image lacks any of the faulty layers.

9. The computer-implemented method of claim 1, further comprising uploading the container image in a repository for subsequent reuse, when the container image lacks any of the faulty layers.

10. The computer-implemented method of claim 1, further comprising reusing the container image to spawn an instance of the container image, when the container image lacks any of the faulty layers.

11. The computer-implemented method of claim 1, wherein said identifying step identifies the fault layers based on repetition of a fault issue in the plurality of layers greater than a threshold number of times.

12. The computer-implemented method of claim 1, wherein the method is used in a Platform as a Service cloud configuration.

13. A computer program product for image blacklisting in a container-based cloud system, the computer program product comprising a non-transitory computer readable storage medium having program instructions embodied therewith, the program instructions executable by a computer to cause the computer to perform a method comprising:
identifying, by one or more processors, faulty layers from among a plurality of layers of a container image stored in the container-based cloud system;
storing, by the one or more processors, information regarding the container image and the faulty layers of the container image;
automatically blacklisting, by the one or more processors, the container image responsive to an identification of one or more of the faulty layers of the container image; and
preventing, by the one or more processors, use of any of the faulty layers in a provisioning process in a container-based cloud system.

14. The computer program product of claim 13, wherein said identifying step comprises identifying the faulty layers by analyzing each of the plurality of layers of the container image for any issues reported with respect to at least selected from the group consisting of provisioning or post provisioning processes.

15. The computer program product of claim 14, wherein the issues reported with respect to the provisioning processes relate to provisioning issues occurring when provisioning instances of one or more of the faulty layers.

16. The computer program product of claim 14, wherein the issues reported with respect to the post-provisioning processes relate to post-provisioning issues reported from instances spawned from one or more of the faulty layers.

17. The computer program product of claim 13, wherein the method is performed with respect to a set of container images, and wherein the information comprises (i) a unique identifier for each of the container images in the set, (ii) issue data for any issues reported with respect to (a) the container images in the set and (b) images instantiated from the container images in the set, and (iii) a blacklisted status of each of the container images in the set.

18. The computer program product of claim 13, wherein the method further comprises provisioning resources in the container-based cloud system using the container image, when the container image lacks any of the faulty layers

19. The computer program product of claim 13, wherein the method is used in a Platform as a Service cloud configuration.

20. A computer processing system, comprising:
one or more processors, configured to:
identify faulty layers from among a plurality of layers of a container image stored in a container-based cloud system;
store information regarding the container image and the faulty layers of the container image;
automatically blacklist the container image responsive to an identification of one or more of the faulty layers of the container image; and
prevent use of any of the faulty layers in a provisioning process in a container-based cloud system.
